(19) United States
(12) Patent Application Publication
(10) Pub. No.: US 2023/0385464 A9
(43) Pub. Date: Nov. 30, 2023

(54) COMPUTER IMPLEMENTS SYSTEM AND METHOD FOR ASSISTING THE DESIGN OF MANUFACTURED COMPONENTS REQUIRING POST-PROCESSING

(71) Applicant: FZ INC., Brossard (CA)

(72) Inventors: Frédéric Poulin, Brossard (CA); Amir Kolaei, Brossard (CA); Somesh Bhatia, Brossard (CA)

(21) Appl. No.: 17/773,221

(22) PCT Filed: Oct. 30, 2020
(86) PCT No.: PCT/CA2020/051475

§ 371 Date: Apr. 29, 2022

Related U.S. Application Data
(60) Provisional application No. 62/928,783, filed on Oct. 31, 2019.

(51) Int. Cl. G06F 30/10; G06F 30/27; G06F 30/28

(52) U.S. Cl. CPC G06F 30/10; G06F 30/27; G06F 30/28; G06F 2113/10

(57) ABSTRACT

A system for assisting the design of manufactured components requiring post-processing and comprising an input module receiving original design data relative to engineering requirements of a component and manufacturing and post-processing data relative to the component. The system also comprising a compensation determination module receiving the original design data and the manufacturing and post-processing data from the input module, predicting the geometrical deviations created by the at least one post-processing procedure and generating dimension compensation data defining compensations for each one of the features of the component using at least one machine learning model generated by a machine learning algorithm trained using a training dataset. The system further comprises a compensated model generation module configured to receive the compensation data and to generate a compensated Computer Assisted Design (CAD) model therefrom. A computer implemented method for assisting the design of manufactured components requiring post-processing is also provided.

### CROSS-REFERENCE TO RELATED APPLICATIONS

This application claims priority under 35USC§ 119(e) of US provisional patent application(s) 62/928,783, filed Oct. 31, 2019, the specification of which being hereby incorporated by reference.

### TECHNICAL FIELD OF THE INVENTION

The present invention relates to the field of industrial manufacturing of components. More particularly, it relates to a system and a method for assisting the design of manufactured components (or parts) requiring post-processing. In an embodiment, the system and method allow prediction of geometrical deviations between an original 3D model of a component to be fabricated and the final post-processed component and the corresponding adjustments of the 3D model of the component, in order to compensate for dimensional changes which will occur during the manufacturing and post-processing phases.

### BACKGROUND

In the field of industrial component manufacturing, it is often required to manufacture components having specific engineering requirements such as, for example and without being limitative, dimensional characteristics, surface roughness, tolerances, etc.

In recent years, a common method used to perform such manufacturing is additive manufacturing, where material is joined to make objects from 3D model data, for example, layer upon layer. This process can however cause deviations, distortions or deformations during the manufacturing process, which leads to components not meeting the geometrical precision requirements. For example and without being limitative, one problem associated with additive manufacturing is associated to part shrinkage which occurs during manufacturing and can lead to the manufactured parts being outside of the accepted dimensional tolerances.

In order to alleviate, this issue, different methods for predicting deviations during the additive manufacturing process and compensating for the predicted deviation have been used. Such methods include 3D printing shrinkage compensation, compensating 3D shape deviations, distortion prediction, minimization for additive manufacturing, etc.

For example, U.S. Pat. No. 9,886,526B2 describes a system and method for compensation of the dimensions for anticipated shrinkage calculated based on the shrinkage information that is associated with a selected shape from a database of different shapes and their associated shrinkage values, which most closely corresponds to the shape of a layer to be printed. The document also describes modifying the information indicative of the shape of the layer to be printed based on the calculated compensation, to minimize errors cause by shrinkage.

US patent application no. US20160320771A1 describes another possible method for predicting deformation errors and compensating for shape deviation in additive manufacturing. In this document, the technology described encompasses scanning a model component manufactured using a specific additive manufacturing machine and generating a point cloud file for the manufactured model component; and comparing the scanned model to the original design (i.e. the CAD model) to generate compensations to be performed from the original design to compensate for deformation during the manufacture of the component by the additive manufacturing machine.

U.S. Pat. No. 9,950,476B2 describes yet another possible method for minimizing distortions in a workpiece manufactured by additive manufacturing. The method described therein uses finite element analysis on a finite element model of the component to conduct a thermomechanical analysis for predicting warping and post-printing deformation. The predicted deformation is used for introducing alterations to the workpiece prior to or during fabrication of the component, to compensate for the predicted deviations.

Other documents describing solutions for minimizing deviations in a workpiece occurring during the manufacture of the workpiece includes, for example, US patent application no. 2018/0341248A1, which describes the use of machine learning-based methods and systems for automated object defect classification of a design geometry of an object (i.e. an original 3D Computer Assisted Design (CAD) model) and adaptive, real-time control of additive manufacturing and/or welding processes for this object.

In view of the above, solutions for compensating for deviations occurring during the manufacturing process of a component (e.g. in the course of an additive manufacturing process) have been proposed. As can be seen, the above-mentioned solutions are, however, all concerned with deviations produced during the additive manufacturing process.

However, an additional concern with manufactured components (e.g. components manufactured using additive manufacturing techniques or other manufacturing techniques such as casting or subtractive manufacturing) is that the components often suffer from poor surface finish. Hence, in many cases, components are required to go through post-processing procedures in order to meet initial engineering dimensional and surface finish requirements. For example, and without being limitative, post-processing can be performed through subtraction (i.e. by removing material), or by addition (i.e. by adding material such as coatings). Often, the post-processing procedures, can unfortunately result in the component being altered to fall out of dimensional specification and/or surface specification requirements. In fact, in many cases, the order of magnitude of geometrical deviations produced during manufacturing is significantly smaller than the geometrical deviation from the manufactured part to the final post-processed part. When post-processing is performed, it is therefore required for the design dimensions of the component to take into account the required post-processing procedures, in order to evaluate the material removal/addition which will occur after manufacturing (i.e. during the post-processing procedures) and compensate for deviations performed during these specific post-processing procedures, such that the final component meets both the surface characteristics requirements and the geometrical precision requirements.

One skilled in the art would understand that there are major differences between the process of predicting the geometrical deviation of a manufactured component manufactured using additive manufacturing and the process of predicting the geometrical deviation of a manufactured component following a surface finishing post-processing, which are completely different by their nature. Where one predicts the deviation from a building/shaping process from an additive (multi-layer welding) manufacturing method for a desired nominal geometry, the other predicts the deviation from a material removal process and/or a coating process from a surface treatment post-processing.

Referring to FIG. 1 (prior art), a typical design and manufacturing cycle for 3D manufactured components, using additive manufacturing, is shown. In the embodiment shown, the process involves the initial design phase of defining the engineering requirements, including, for example and without being limitative, the dimensions, surface finish characteristics (i.e. surface roughness conditions), tolerances and materials for the manufacture of the component (step 101). These engineering requirements are the basis on which the original model of the component (or CAD model) is subsequently generated (step 102).

Once the original model has been generated, the CAD data associated to the original model (i.e. the data of the original model of the component (CAD model)) can be transferred to a slicer software (step 103) generating machine instructions for an associated additive manufacturing apparatus (or 3D printer). At this stage, the additive manufacturing parameters of the component such as, for example and without being limitative, the layer thickness, the print speed, the orientation of the component in the printer while the component is manufactured, etc., are defined. One skilled in the art will understand that the parameters which are defined at this stage have a high impact on the potential deviations, the quality of the manufactured components and the characteristics thereof, such as surface finish characteristics or the like. Indeed, a large layer thickness, for example and without being limitative, can result in a coarse surface finish. In addition, the printing orientation greatly influence the finishing of the different side surfaces of each component. Furthermore, the selected material, the printing technology, and the geometry of the component are additional factors which impact the quality of the manufactured components and the characteristics thereof. For example, small holes with dimensions approaching the printer resolution are most likely to have inaccurate dimensions.

Once the machine instructions for the associated additive manufacturing apparatus (3D printer) are generated by the slicer program, a 3D printer can perform the additive manufacturing process (3D printing) (step 104). However, due to the above-mentioned bias which can occur depending on the selected printing parameters and the multiple variables involved in the process, components manufactured using additive manufacturing technologies commonly require subsequent post-processing procedures, in order to make the component usable for the intended purpose. Hence, in order to meet the engineering requirements, the manufactured component often requires an additional aging or heat treatment procedure (step 105) and/or surface post-processing and surface treatment procedures (step 106).

The step of performing the surface post-processing and finishing procedures (step 106) on the component commonly entails removing material from specific surfaces (for example using cutting, drilling, machining, abrasive flow machining, electrochemical polishing, automatic lapping, tumble finishing or the like) until the surface finish is within finishing requirement specifications. In many cases, this creates a discrepancy between the dimensions of the finished component and those of the original design (i.e. the dimensions of the original CAD model as specified in the engineering requirements). Indeed, while removing material to achieve the required surface roughness and quality, the geometrical dimensions of the component can deviate from the specified tolerance values, thereby resulting in non-compliance of the component with the dimensional engineering requirements and can lead to discarding of the component. One skilled in the art will understand that the rate at which the material is removed from the component during post-processing, depends on several factors such as the procedure used, the component material, the geometry and features of the component being processed, etc. For example, and without being limitative, a small diameter hole will lose material at a different rate from a curved outer surface of a component. One skilled in the art will also understand that, in alternative embodiments, the post-processing and finishing procedures on component could also entail adding material (for example a coating being applied) on specific surfaces or features of the component.

Hence, one skilled in the art will easily understand that, predicting how much material will be lost through different post-processing and/or finishing processes, for different component materials and geometries would provide several advantages and can save lots of time on design iterations and materials. It will also increase the repeatability and precision of components manufactured, for example, using additive manufacturing. It will also be understood that the same could be said for predicting how much material would be added through a post-processing procedure and/or finishing processes, when treating different component materials and geometries.

In view of the above, there is a need for an improved system and method for assisting the design of manufactured components requiring post-processing, which would be able to overcome or at least minimize some of the above-discussed prior art concerns.

### SUMMARY OF THE INVENTION

In accordance with a first general aspect, there is provided a system for assisting the design of manufactured components requiring post-processing, through prediction of geometrical deviations created by at least one post-processing procedure to be performed on a component following a manufacture thereof. The system comprises an input module receiving original design data relative to a component to be manufactured and requiring post processing. The original design data define engineering requirements of the component including a material of the component, a geometry of the component defining features and dimensional accuracy thereof and a surface finish. The input module further receives manufacturing and post-processing data including the at least one post-processing procedure to be performed on the manufactured component and specific parameters of the at least one post-processing procedure. The system also comprises a compensation determination module receiving the original design data and the manufacturing and post-processing data from the input module. The compensation determination module is configured to predict the geometrical deviations created by the at least one post-processing procedure and generate dimension compensation data defining compensations for each one of the features of the component. The dimension compensation data is generated using at least one machine learning model generated by a machine learning algorithm that has been trained using a training dataset. The system further comprises a compensated model generation module configured to receive the compensation data from the compensation determination module and to generate a compensated Computer Assisted Design (CAD) model including the compensations for each one of the features of the component, to counterbalance the deviation to be caused by the at least one post-processing procedure.

In an embodiment, the original design data comprises an original CAD model of the component responding to the engineering requirements.

In an embodiment, the manufacturing and post-processing data comprises data relative to the identification of the manufacturing process, the identification of the specific apparatus used for the manufacturing process and the material used in the manufacturing process.

In an embodiment, the compensation determination module is configured to generate the dimension compensation data defining different compensations for each one of the features of the component. The compensation corresponding to each one of the features of the component is adapted to the positioning and configuration of the corresponding feature.

In an embodiment, the compensation determination module is further configured to generate the compensation data using calculated deviations from theoretical modeling of the deviations for each one of the features in combination with the at least one machine learning model.

In an embodiment, the theoretical modeling includes a computational fluid dynamics (CFD) analysis relative to the features defining the geometry of the component, the material of the component, an abrasive media used as fluid for the at least one post processing procedures and the specific parameters of the post-processing procedure.

In an embodiment, the system further comprises a manufacturing and post-processing unit comprising a manufacturing apparatus configured to receive the compensated CAD model and to manufacture the component according to parameters of the compensated CAD model and a post-processing apparatus configured to perform the at least one post-processing procedure on the component manufactured according to the compensated CAD model.

In an embodiment, the manufacturing apparatus is a 3D printer manufacturing the component using additive manufacturing.

In an embodiment, the system further comprises a machine learning module including an artificial intelligence unit implementing the machine learning algorithm trained using the training dataset, a manufactured component measurement module configured to acquire dimensional data relative to the features of a manufactured component after the component has been manufactured and a post-processed component measurement module configured to acquire dimensional data relative to the features of the component after the component has gone through the at least one post-processing procedure. The data acquired by the manufactured component measurement module and the post-processed component measurement module is correlated with the engineering requirements of the component and information from the manufacturing and post-processing data to populate the training dataset.

In accordance with another general aspect, there is further provided a system for assisting the design of manufactured components requiring post-processing. The system comprises an input module receiving original design data relative to a component to be manufactured and requiring post processing. The original design data include an original CAD model of the component respecting engineering requirements including a material of the component, a geometry of the component defining features and dimensional accuracy thereof and a surface finish. The input module further receives manufacturing and post-processing data including the at least one post-processing procedure to be performed on the manufactured component and specific parameters of the at least one post-processing procedure. The system also comprises a compensation determination module receiving the original design data and the manufacturing and post-processing data from the input module. The compensation determination module is configured to predict the geometrical deviations created by the at least one post-processing procedure and to generate dimension compensation data defining compensations to be applied on the original CAD model for each one of the features of the component. The dimension compensation data is generated using a combination of empirical analysis performed by at least one machine learning model generated by a machine learning algorithm trained using a training dataset and theoretical modeling of the deviations for each one of the features using at least one theoretical model. The system also includes a compensated model generation module configured to receive the compensation data from the compensation determination module and to generate a compensated CAD model based on the original CAD model further including the compensations for each one of the features of the component defined therein, to counterbalance the deviation to be caused by the at least one post-processing procedure.

In an embodiment, the manufacturing and post-processing data comprises data relative to the identification of the manufacturing process, the identification of the specific apparatus used for the manufacturing process and the material used in the manufacturing process.

In an embodiment, the compensation determination module is configured to generate dimension compensation data defining different compensations for each one of the features of the component of the original CAD model. The compensation corresponding to each one of the features of the component being adapted to the positioning and configuration of the corresponding feature.

In an embodiment, the theoretical modeling includes a computational fluid dynamics (CFD) analysis relative to the features defining the geometry of the component, the material of the component, an abrasive media used as fluid for the at least one post processing procedures and the specific parameters of the post-processing procedure.

In an embodiment, the system further comprises a manufacturing and post-processing unit comprising a manufacturing apparatus configured to receive the compensated CAD model and to manufacture the component according to parameters of the compensated CAD model and a post-processing apparatus configured to perform the at least one post-processing procedure on the component manufactured according to the compensated CAD model.

In an embodiment, the manufacturing apparatus is a 3D printer manufacturing the component using additive manufacturing.

In an embodiment, the system further comprises a machine learning module including an artificial intelligence unit implementing the machine learning algorithm trained using the training dataset, a manufactured component measurement module configured to acquire dimensional data relative to the features of a manufactured component after the component has been manufactured and a post-processed component measurement module configured to acquire dimensional data relative to the features of the component after the component has gone through the at least one post-processing procedure. The data acquired by the manufactured component measurement module and the post-processed component measurement module is correlated with the engineering requirements of the component and information from the manufacturing and post-processing data to populate the training dataset.

In accordance with another general aspect, there is further provided a computer implemented method for assisting the design of manufactured components requiring post-processing, through prediction of geometrical deviations created by at least one post-processing procedure to be performed on a component following a manufacture thereof. The method comprises the steps of: acquiring original design parameters relative to the component to be manufactured according to engineering requirements, the engineering requirements including the material of the component, the geometry of the component defining features and dimensional accuracy thereof and the surface finish; acquiring manufacturing and post-processing input parameters regarding the component including the at least one post-processing procedure to be performed on the manufactured component and specific parameters of the at least one post-processing procedure to generate a finished component; providing a training dataset, wherein the training dataset comprises measurement data relative to geometric deviations caused by different post-processing procedures and for different component features, component geometries and component materials, which are similar or different from the engineering requirements of the component; predicting compensations for each one of the features of the component corresponding to deviations to occur subsequently during the at least one post-processing procedure such that the finished component respects the engineering requirements regarding the dimensional accuracy and the surface finish and generating dimension compensation data for the features of the component, wherein the prediction of the compensations are determined using a machine learning model generated by a machine learning algorithm trained using the training dataset; and generating a compensated CAD model including compensations for the predicted deviations to occur to the corresponding features of the component during the at least one post-processing procedure based on the dimension compensation data, the compensated CAD model including specific compensations for each one of the features of the component.

In an embodiment, the further comprises the step of manufacturing the component according to the compensated CAD model.

In an embodiment, the further comprises the step of performing the at least one post-processing procedure on the manufactured component, to generate the finished component.

In an embodiment, the further comprises the steps of: measuring the component after the component has been manufactured in accordance with the compensated CAD model; measuring the component after the at least one post processing procedure has been performed on the manufactured component; and updating the training dataset using the data relative to measurement differences between the measurements after the component has been manufactured and after the at least one post processing procedure has been performed on the manufactured component correlated with the engineering requirements of the component and the manufacturing and post-processing input parameters relative thereto.

In an embodiment, the step of predicting compensations for each one of the features of the component comprises the substeps of analyzing an original CAD model and identifying features of the component defining the geometry of the component and calculating the deviation to be caused by the post-processing procedures for each one of the identified features and including compensation for each one of the identified features in the generated compensation data.

In an embodiment, the step of calculating the deviation to be caused by the post-processing procedures for each one of the identified features can further include generating deviation data using theoretical modeling of the deviations for each one of the features from at least one theoretical model.

### BRIEF DESCRIPTION OF THE DRAWINGS

Other objects, advantages and features will become more apparent upon reading the following non-restrictive description of embodiments thereof, given for the purpose of exemplification only, with reference to the accompanying drawings in which:

FIG. 1 (Prior Art) is a flowchart representation of a conventional design and manufacturing process, using additive manufacturing, in accordance with an embodiment.

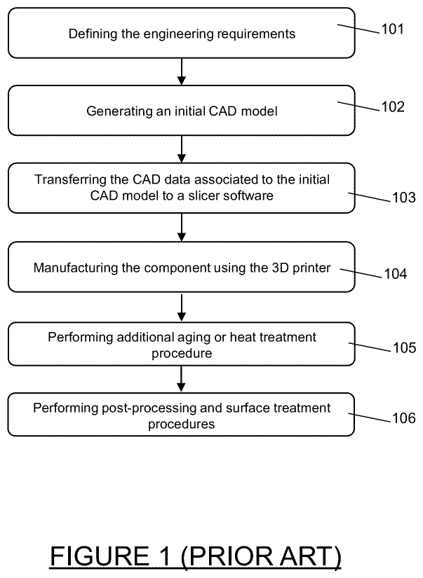

FIG. 2 is schematic representation of a system for assisting the design of manufactured components requiring post-processing and the manufacturing of such components, using additive manufacturing, in accordance with an embodiment.

FIG. 3 is a schematic representation of a system including machine learning for assisting the design of manufactured components requiring post-processing, in accordance with an embodiment.

FIG. 4 is a cross-sectional view of an exemplary component to be manufactured using an additive manufacturing process, in accordance with an embodiment.

FIG. 5 is a cross-sectional view of the exemplary component of FIG. 4, shown with compensated sections, as determined by the system and/or the method for assisting the design of manufactured components requiring post-processing described herein.

FIG. 6 is a flowchart presenting the steps of a computer implemented method for assisting the design of manufactured components requiring post-processing, in accordance with an embodiment.

FIG. 7 is a flowchart presenting the steps of a subprocess for providing a training dataset and training the machine learning algorithm, in accordance with an embodiment.

### DETAILED DESCRIPTION

In the following description, the same numerical references refer to similar elements. The embodiments, geometrical configurations, materials mentioned and/or dimensions shown in the figures or described in the present description are embodiments only, given solely for exemplification purposes.

Moreover, although the embodiments of the system for assisting the design of manufactured components requiring post-processing and corresponding parts thereof consist of certain components as explained and illustrated herein, not all these components are essential and thus should not be taken in their restrictive sense. It is to be understood, as also apparent to a person skilled in the art, that other suitable components and cooperation thereinbetween may be used for the system for assisting the design of manufactured components requiring post-processing, as will be briefly explained herein and as can be easily inferred herefrom by a person skilled in the art. Moreover, although the associated method includes steps as explained and illustrated herein, not all these steps are essential and thus should not be taken in their restrictive sense. It will be appreciated that the steps of the method for assisting the design of manufactured components requiring post-processing described herein may be performed in the described order, or in any suitable order.

To provide a more concise description, some of the quantitative and qualitative expressions given herein may be qualified with the terms “about” and “substantially”. It is understood that whether the terms “about” and “substantially” are used explicitly or not, every quantity or qualification given herein is meant to refer to an actual given value or qualification, and it is also meant to refer to the approximation to such given value or qualification that would reasonably be inferred based on the ordinary skill in the art, including approximations due to the experimental and/or measurement conditions for such given value.

In the present description, the term “computing device” encompasses computers, servers and/or specialized electronic devices which receive, process and/or transmit data. “Computing devices” are generally part of “systems” and include processing means, such as microcontrollers and/or microprocessors, CPUs or are implemented on FPGAs, as examples only. The processing means are used in combination with storage medium, also referred to as “memory” or “storage means”. Storage medium can store instructions, algorithms, rules and/or trading data to be processed. Storage medium encompasses volatile or non-volatile/persistent memory, such as registers, cache, RAM, flash memory, ROM, as examples only. The type of memory is of course chosen according to the desired use, whether it should retain instructions, or temporarily store, retain or update data.

As can be appreciated, one skilled in the art will understand that the modules described below can be implemented via programmable computer components, such as one or more physical or virtual computing device comprising a processor and memory. It is appreciated, however, that other configurations are also possible.

Moreover, the modules and data sources described herein can be in data communication through direct communication such as a wired connection or via a network allowing data communication between computing devices or components of a network capable of receiving or sending data, which includes publicly accessible networks of linked networks, possibly operated by various distinct parties, such as the Internet, private networks (PN), personal area networks (PAN), local area networks (LAN), wide area networks (WAN), cable networks, satellite networks, cellular telephone networks, etc. or combination thereof.

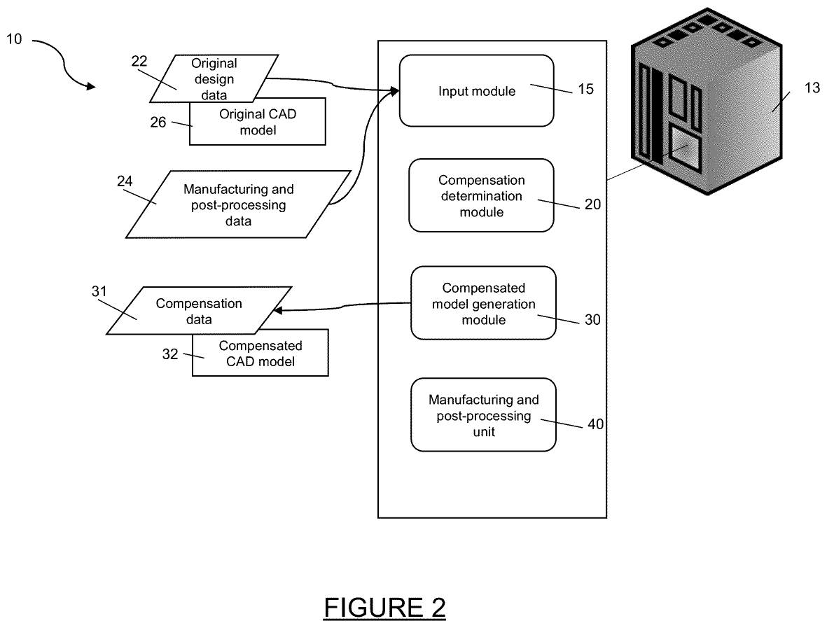

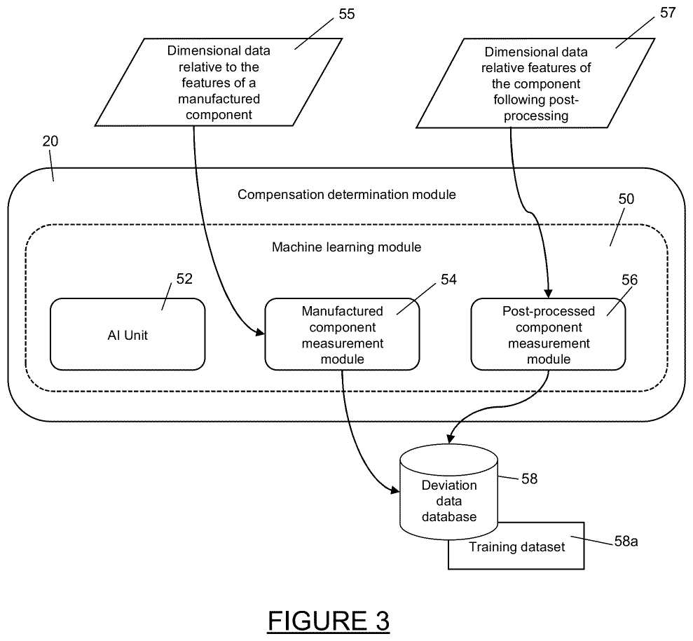

Referring generally to FIGS. 2 and 3, an embodiment of the system 10 for assisting the design of manufactured components requiring will be described in more details below. The system 10 is designed and configured to accurately predict the geometrical deviations to occur during the post-processing procedures following the manufacturing process and to adjust the original CAD model 26 and to compensate such deviations. The system 10 can therefore generate an adjusted CAD model 32, which can subsequently be used to manufacture components which will comply with dimensional engineering requirements, following the post-processing procedures.

In the course of the present application, the expression «post-processing procedures» is used to refer to all conventional or special surface finishing processes which impact on the external or internal surfaces of the component (i.e. add or subtract material from the surface) and result in the surfaces of the component meeting the surface finish engineering requirements. One skilled in the art will understand that the post-processing procedures can be a chemical procedure and/or a mechanical procedure or can combine both a chemical procedure and a mechanical procedure. For example, and without being limitative post-processing procedures can include cutting, drilling, machining, abrasive flow machining, electrochemical polishing, automatic lapping, tumble finishing, etc.

In view of the above, one skilled in the art will understand that, in most cases, the geometrical deviations created by the post-processing procedures correspond to material loss caused by the required removal of material to meet the surface finish requirements and therefore require compensation by addition of material to the features of the component defined in the original CAD model 26. One skilled in the art will however understand that, in alternative embodiments, the deviation could also be the result of addition of material, which could, for instance, occur as a result of a coating being applied to selected features or to a section of the component. In such embodiments. Compensation are performed by subtraction of material from the features of the component defined in the original CAD model 26.

As will be described in more details below, in an embodiment, the system 10 for assisting the design of manufactured components requiring post-processing uses the engineering requirements for the component to be manufactured as well as other parameters regarding the manufacture of the component as inputs in order to predict the deviations which will occur during the post-processing process. In an embodiment the system 10 can also use the engineering requirements for the component to be manufactured as well as the other parameters regarding the manufacture of the component, to predict the deviations which will occur during the manufacturing thereof. For example and without being limitative, in an embodiment, the parameters used can include data regarding the initial design dimensions of the component, the manufacturing process, the material of the component, the geometry of the component and the post-processing process being applied to the component following the manufacture thereof. Considering the input parameters, the system 10 can generate dimension compensations for the different features of the component (i.e. generate specific compensations for different segments (or portions) of the component). These compensation values can therefore be added or subtracted from the original CAD model 26 of the component for each feature, therefore generating an adjusted CAD model 32.

In view of the above, it will be understood that, using the present system 10, once the adjusted CAD model 32 has been generated, the component can be manufactured according to the adjusted CAD model 32 and be post-processed to meet the surface finish requirements. The manufactured and post-processed components based on the adjusted CAD model 32 can therefore meet both the dimensional and surface finish requirements specified in the engineering requirements of the original design data 22 for the component (i.e. be post-processed without falling out of spec due to the deviations generated during the post-processing procedures).

As will be described in more details below, in an embodiment, the system 10 can use machine learning in order to predict accurate compensation values for the component, based on the original design data 22. In such an embodiment, the system 10 therefore encompasses artificial intelligence algorithms generating deviation prediction models stored in a memory of a computing device, using a training dataset 58a. In an embodiment, the training dataset 58a can be updated, using data obtained from manufactured and post-processes components over time. Hence, in such an embodiment, the Artificial Intelligence capability of the system 10 will cooperate with the other modules of the system 10, to allow the system 10 to become more precise and versatile over time.

In an embodiment, the training dataset 58a comprises measurement data relative to geometric deviations caused by different post-processing procedures and for different component features, component geometries and component materials. In an embodiment, the training dataset 58a can be stored in a deviation data database 58, with the data of the deviation data database 58 being repeatedly updated by the system 10, based on data acquired or generated therefrom.

Therefore, in an embodiment the training dataset 58a includes data gathered following instances of post-processing procedures of components and identifying the variation in the measurement of the different features of the components caused by the specific post-processing procedure, for the specific component material and component features of each instance and stored in the deviation data database 58. In other words, the data included in the training dataset 58a can be generated by experimentation using an array of post-processing and finishing procedures, finishing materials, component materials, and component geometries and features generated through operation of the system 10, as will be described in more details below. Each component used in the experimentations can be designed using specific engineering requirements and defined by an original CAD model 26. The components can subsequently be manufactured, post-processed and precisely measured, to assess the geometrical deviations (e.g. the material loss) for each one of the different component features, in the associated post-processing procedure, with the data generated being stored in the deviation data database 58.

Referring specifically to FIG. 2, an embodiment of the system 10 for assisting the design of manufactured components requiring post-processing is shown. In the embodiment shown in FIG. 2, the system 10 includes one or more computing device 13 having a memory for storing instructions and a processor for executing the instructions.

In the embodiment shown, the system 10 includes an input module 15 receiving original design data 22 relative to a component to be manufactured (and requiring post processing) and allowing data acquisition and transfer thereof. In an embodiment, the original design data are relative to initial engineering requirements for a component and include at least the component dimensions, the geometry of the component defining features and dimensional accuracy (or dimensional tolerances) thereof, the material and the surface roughness (or surface finish). In an embodiment, the original design data 22 include the original CAD model 26 of the component, defining the component designed using a CAD software and meeting the above-mentioned engineering requirements. One skilled in the art will understand that the original design data 22 can be received from one or more internal or external and public or private data sources, such as databases, repositories, data stores, etc. In an embodiment, the input module 15 can receive portion of original design data 22 from different data sources, and merge and/or format the acquired data to form the original design data 22.

In an embodiment, the input module 15 also receives manufacturing and post-processing data 24 and allows data acquisition and transfer thereof. For example and without being limitative, in an embodiment the manufacturing and post-processing input data 24 can include information relative to the identification of the manufacturing process, the identification of the specific apparatus used for the manufacturing process (e.g. the make and model of the 3D printer), the material used in the manufacturing process, the post-processing procedures which will be performed on the manufactured component, and the specific parameters of the post-processing procedures (e.g. the description of the post-processing process, the media being used, the time interval of the prost-processing process, the required finish, etc.). Once again, one skilled in the art will understand that the manufacturing and post-processing data 24 can be received from one or more internal or external and public or private data sources, such as databases, repositories, data stores, etc. In an embodiment, the input module can receive portion of the manufacturing and post-processing data 24 from different data sources, and merge and/or format the acquired data to form the manufacturing and post-processing data 24.

The system 10 further comprises a compensation determination module 20 receiving data from the input module 15 and generating compensation data 31 corresponding to the compensations to be applied to each one of the features of the component having the characteristics defined in the original design data 22 and corresponding to the original 3D CAD model 26.

In an embodiment, the compensation determination module 20 is configured to predict post-processing outcomes (i.e. predict deviations which will be generated by the post-processing procedures for each feature defining the geometry of the component). In an embodiment, the compensation determination module 20 is configured to initially analyze the original 3D CAD model 26 and identify the features of the component which define the geometry of the original design. Based on the identified features, the compensation determination module 20 is further configured to calculate (or estimate) the deviation to be caused by the post-processing procedures for each one of the identified features.

In an embodiment, the compensation determination module 20 is configured to predict the deviation to be caused by the post-processing procedures using a combination of statistical analysis of variations of corresponding features (defining different geometries) in previous evaluations, taking into account the material and post-processing procedures used in the previous evaluations and the current material and post-processing procedure to be performed (i.e. empirical analysis) and calculated deviations using theoretical modeling of the deviations for each one of the features based on at least one theoretical model. One skilled in the art will understand that, in alternative embodiments, the prediction of the deviation to be caused by the post-processing procedures could be performed using only an empirical analysis.

In an embodiment where an abrasive media is used for the post-processing procedures, the theoretical modeling can be performed using numerical analysis for the impact of the abrasive media used for the post-processing procedures on the features defining the geometry of the component. For example and without being limitative, in an embodiment, a computational fluid dynamics (CFD) analysis relative to the features defining the geometry of the component, the material of the component, the abrasive media used as fluid for the post-processing procedures, and the specific parameters of the post-processing procedure (time, required finish, etc.) can be performed to model the removal of material which will occur during the post-processing procedure

Referring to FIG. 3, in an embodiment, the compensation determination module 20 can include a machine learning module 50 for generating the machine learning model 52a performing the empirical analysis. The machine learning module 50 is thereby a submodule of the compensation determination module 20.

In an embodiment, the machine learning module 50 includes an artificial intelligence unit (Al unit) 52 implementing an artificial intelligence algorithm (Al algorithm) configured to learn and generate the machine learning models 52a, using the generated training datasets 58a, thereby continuously improving the quality of the output (or predictions) provided by the compensation determination module 20. Indeed, as previously mentioned, in an embodiment, the training dataset 58a is repeatedly updated using data obtained regarding post-processing of components having different geometries and material and being post-processed according to different procedures and post-processing parameters, such that the Al algorithm implemented by the Al unit 52, can repeatedly use the latest version of the training dataset, in order to generate an updated and improved machine learning model 52a.

One skilled in the art will understand that several different machine learning algorithms could be used to implement the Al algorithm of the artificial intelligence unit 52. For example, and without being limitative, this could include, artificial neural network algorithms, Gaussian process regression algorithms, fuzzy logic-based algorithms, decision tree algorithms, etc. Moreover, in an embodiment, more than one Al algorithm could be used such that hybrid machine learning algorithms including features and properties drawn from more than one type of machine learning algorithms could be used to implement the disclosed Al unit 52 and machine learning module 50 of the system 10.

In an embodiment, the machine learning module 50 includes a manufactured component measurement module 54 configured to acquire dimensional data relative to the features of a manufactured component (i.e. the dimensions of the features of the component after the component has been manufactured, for example by 3D printing using a 3D printer). In an embodiment, the dimensional data relative to the features of a manufactured component acquired by the manufactured component measurement module 54 allows the comparison of the dimensions of the manufactured component with those of, for example, the compensated CAD model 32 used for the manufacture thereof. In an embodiment, the dimensional data acquired by the manufactured component measurement module 54 include high-precision measurement data concerning the geometrical dimension and surface properties of the manufactured component and its features. For example and without being limitative, the high-precision measurement data can be acquired from measurement components, using surface profilometry, non-contact profilometry, coordinate measuring devices, 3D scanning, hand metrology or the like.

In an embodiment, the dimensional data relative to the features of a manufactured component can be transmitted to the deviation data database 58 and stored thereon.

In the embodiment shown, the machine learning module 50 further includes a post-processed component measurement module 56 configured to acquire dimensional data 57 relative to the features of the component after the component has gone through the post-processing procedures. In an embodiment, the dimensional data relative to the features of the component after the component has gone through the post-processing procedures acquired by the post-processed component measurement module 56 allows the comparison of the dimensions of the post-processed component with those of the previously measured manufactured component (i.e. the dimensional data acquired by the manufactured component measurement module 54). Once again, in an embodiment, the dimensional data relative to the features of the component after the component has gone through the post-processing procedures acquired by the post-processed component measurement module 56 includes high-precision measurement data concerning the geometrical dimension and surface properties of the post-processed component and its features. Once again, for example and without being limitative, the high-precision measurement data can be obtained from measurement instruments using surface profilometry, non-contact profilometry, coordinate measuring devices, 3D scanning, hand metrology or the like.

In an embodiment, the dimensional data relative to the features of the component after the component has gone through the post-processing procedures can be transmitted to the deviation data database 58 and stored thereon. In an alternative embodiment the dimensional data relative to the features of a manufactured component and/or the dimensional data relative to the features of the component after the component has gone through the post-processing procedures can be processed before being stored in the deviation data database 58. For example and without being limitative, in an embodiment, only the deviation (or dimensional measurement differences) between the dimensional data relative to the features of a manufactured component and/or the dimensional data relative to the features of the component after the component has gone through the post-processing procedures can be stored in the deviation data database 58. One skilled in the art will understand that, in an embodiment, the dimensional data relative to the features of a manufactured component and/or the dimensional data relative to the features of the component after the component has gone through the post-processing procedures (or the derived processed data) can be stored on the deviation data database 58 and correlated with the engineering requirements of the corresponding component, including, for example the specific component material and component features specifications and the information of the manufacturing and post-processing data.

In view of the above, one skilled in the art will understand that the data acquired by the manufactured component measurement module 54 and the post-processed component measurement module 56 and correlated with the engineering requirements of the corresponding component and information of the manufacturing and post-processing data thereof can be used to update (or populate) the training dataset 58a (for example stored in the deviation data database 58) used to train the Al algorithm of the Al unit 52, using data from the manufactured component measurement module 54 and the post-processed component measurement module 56 for several instances of manufactured components.

Hence, it will be understood that the larger the training dataset 58a of different post-processing parameters and outcomes becomes, the more accurate the machine learning model 52a generated by the Al algorithm of the Al unit 52, which can be used by the compensation determination module 20 of the system 10, can become in predicting the required dimension compensation.

Referring back to FIG. 2, in the embodiment shown, the system 10 further includes a compensated model generation module 30, receiving the compensation data 31 from the compensation determination module 20 and generating a compensated design (i.e. a compensated 3D CAD model 32) based on the original CAD model 26 and including compensations for the predicted deviations to occur during the post-processing procedures, as determined by the compensation determination module 20. In an embodiment, the compensation data 31 can also include deviation to occur during the manufacturing of the component and the compensated 3D CAD model 32 can therefore be based on the original CAD model 26 and including compensations for the predicted deviations to occur for the features of the component, during the combination of the manufacturing and the post-processing procedures.

Once the compensated 3D CAD model 32 is generated by the compensated model generation module 30, the compensated model data relative to the compensated 3D CAD model 32 can be transferred to a manufacturing and post-processing unit 40 including the specific apparatuses used for the manufacturing process and the specific post-processing procedures as defined in the manufacturing and post-processing data 24 received by the input module 15 and used by the compensation determination module 20.

The manufacturing and post-processing unit 40 can include any apparatus (or combination of apparatuses) for manufacturing a component and performing the post-processing procedures in conformity with the information of the manufacturing and post-processing data 24. For example, in an embodiment where the manufacturing unit is a 3D printer, the manufacturing and post-processing unit 40 can operate to transfer the data relative to the compensated CAD model 32 generated by the compensated model generation module 30 to a slicer software, which generates machine instructions for the associated 3D printer that subsequently performs the additive manufacturing process, the aging and/or the heat treatment procedure. In an embodiment, the manufacturing and post-processing unit 40 can further include a machining apparatus performing the post-processing and finishing procedures. One skilled in the art will however understand that, in alternative embodiments, the manufacturing and post-processing unit 40 could rather include apparatuses performing one of cutting, drilling, machining, abrasive flow machining, electrochemical polishing, automatic lapping, tumble finishing, or the like required for the post-processing and finishing procedures.

One skilled in the art will also understand that, in an embodiment, each one of the compensation determination module 20, the compensated model generation module 30, and the machine learning module 50 can be implemented via software running on one or more computing device having a memory capable of storing instructions and a processor for processing the instructions and capable of implementing these modules.

One skilled in the art will understand that each one of the compensation determination module 20, the compensated model generation module 30, and the machine learning module 50 can be partially or entirely embodied on the same computing device or on remote computing device(s) communicating with one another over a network, such as, for example and without being limitative, a local area network (LAN), a wide area network (WAN) such as the Internet, or the like. Moreover, the training dataset used by the above described compensation determination module 20 and the machine learning module 50 can be hosted directly on the same computing device or on a remote computing device(s) communicating therewith over a network.

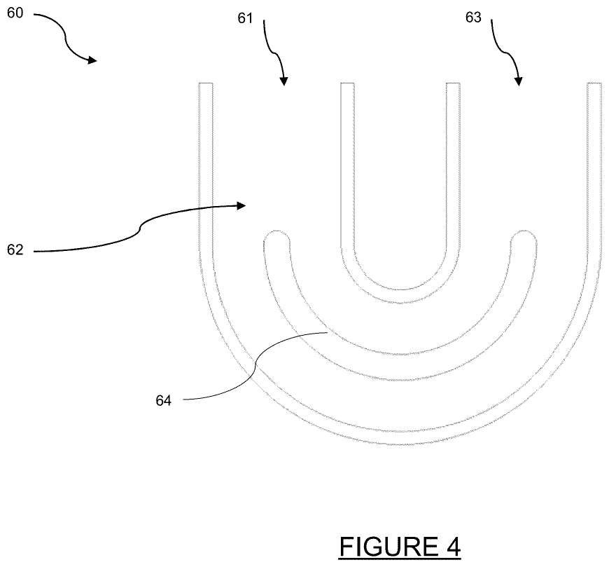

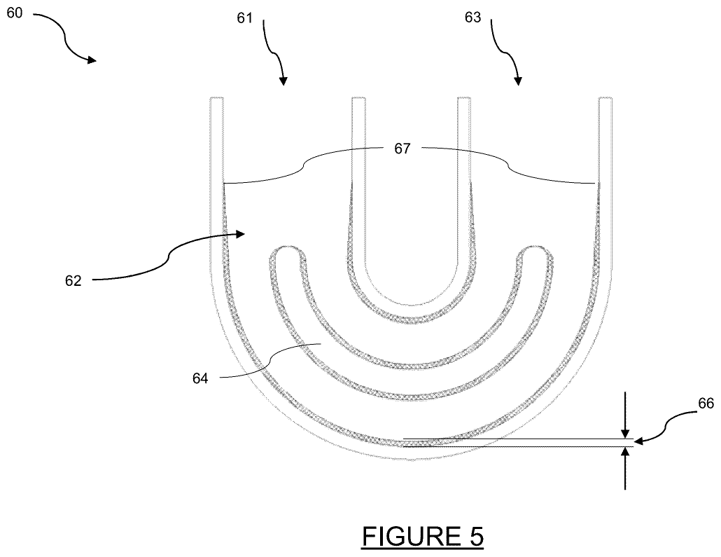

Now turning to FIGS. 4 and 5, the Figures show an exemplary embodiment of a component 60 for which the above described system 10 for assisting the design of manufactured components requiring post-processing can be used. In FIG. 4, the component 60 includes a U-channel 62 with an internal vane 64 for fluid flow regulation, which is a typical example of a component produced using additive manufacturing. In such a component 60, characteristics such as inlet 61 and outlet 63 radii, vane dimensions, surface finish, and all geometry profiles are critical to the optimal flow of fluid therein and should therefore be within the tolerance thresholds as specified in engineering requirements thereof. However, producing the component 60 according to the required surface finish, requires post-processing, often performed through material removal. As mentioned above, such material removal can cause the component 60 to be outside of the predetermined geometrical tolerances for this specific component 60, following post-processing, therefore negatively impacting the fluid flow therein or the required strength or resistance of the component.

Hence, to ensure that the component 60 remains within the geometrical tolerances, the system 10 for assisting the design of manufactured components requiring post-processing can predict the deviation to be created by the post-processing procedures and compensate the dimensions of specific features of the component 60 with extra material, as seen in FIG. 5. The compensation of the dimensions of the specific features are provided by generating the compensated CAD model 32, using the compensated model generation module 30 and based on the compensation data generated by the compensation determination module 20. The hatching in FIG. 5 shows the material added to the different features of the component 60 to compensate for the loss which will occur during post-processing procedures. As will be easily understood and as can be seen in FIG. 5, different features of the component are compensated differently (i.e. are compensated through addition of a different thickness of material) depending on the multiple parameters of the post-processing procedures (e.g. the type of post-processing, the length of the post-processing procedures, etc.). As described above, in an embodiment, the different features can also be compensated differently depending on the multiple parameters of the manufacturing process (i.e. in this embodiment depending on the 3D printing process, the 3D printer used, the 3D printing parameters, the material, etc.).

For exemplification purposes, FIG. 5 shows basic compensation for the inner diameter of the channel 62 as well as the outer surface of the vane 64. Factors such as the thickness of each one of the compensation layers 66, the length of each compensation layer (i.e. the position 67 of the extremities of the compensation layers), the thickness variations of different portions of the each compensation layers, etc. are determined by the compensation determination module 20 and defined in the compensation data.

One skilled in the art will understand that the exemplary compensations shown in FIG. 5 are not exhaustive but are rather shown solely for exemplification purposes. It will be understood that, for example and without being limitative, numerous additional variations of thickness in the compensation layers can be provided. In fact, the combinations of different compensation portions are practically unlimited.

The system 10 for assisting the design of manufactured components requiring post-processing having been described above, the associated computer implemented method 100 for assisting the design of manufactured components requiring post-processing will now be described in more details below.

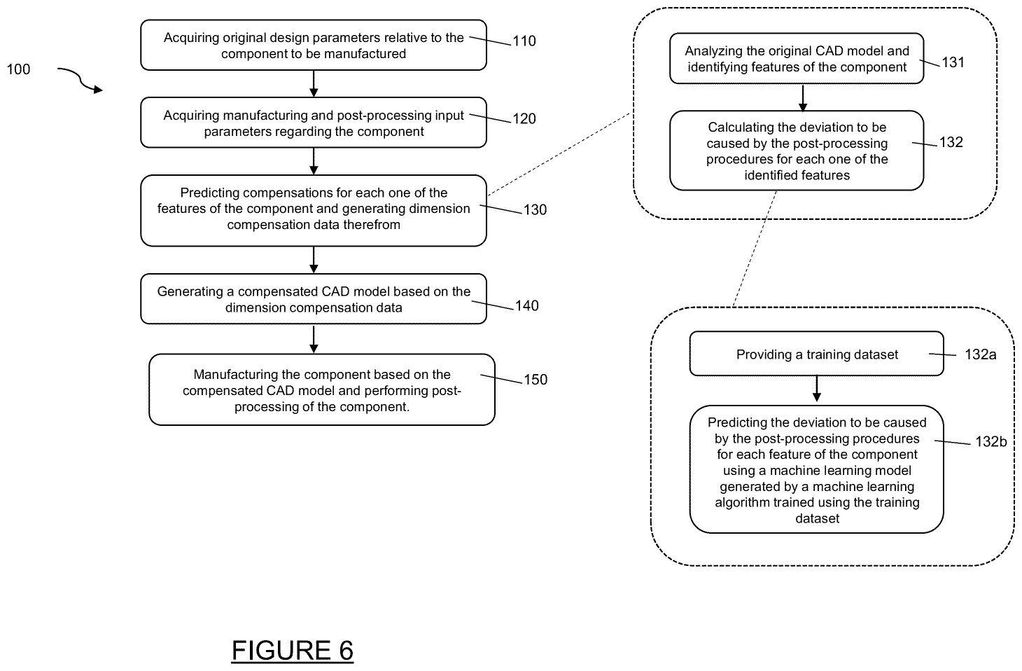

Referring to FIG. 6, in an embodiment, the method 100 includes the initial step 110 of acquiring original design parameters relative to the component to be manufactured (and requiring post processing) in accordance with engineering requirements including at least the component dimensions, the geometry of the component defining features and dimensional accuracy (or dimensional tolerances) thereof, the material and the surface roughness (or surface finish). In an embodiment, at this step, the original CAD model of the component, defining the component designed using a CAD software and meeting the above-mentioned engineering requirements can be acquired.

In an embodiment, the method 100 further comprises the step 120 of acquiring manufacturing and post-processing input parameters regarding the component. For example, and without being limitative, in an embodiment, the manufacturing and post-processing input parameters can include, input data regarding at least a subset of the manufacturing process, the apparatus used for the manufacturing process, the material of the component, the post-processing procedures and the specific parameters thereof.

In an embodiment, the method 100 further includes the step 130 of predicting compensations for each one of the features of the component corresponding to deviations to occur subsequently during the at least one post-processing procedure, such that the finished component respects the engineering requirements regarding the dimensional accuracy and the surface finish, and generating dimension compensation data for the features of the component. The dimension compensation data defines compensation parameters identifying modifications to be performed on the component to counterbalance the deviation to be caused by the post-processing procedures.

In an embodiment, the method further includes the step 140 of generating a compensated CAD model based on the dimension compensation data and compensating for the predicted deviations to occur during the manufacturing and the post-processing procedures. In an embodiment, the generated compensated CAD model includes compensations for the predicted deviations to occur on each corresponding features of the component.

In an embodiment, the method includes the further step 150 of transmitting the data representative of the compensated CAD model to a manufacturing and post-processing unit and manufacturing the component based on the compensated CAD model, and performing post-processing of the component in order to generate a finished component. In view of the above, it will be understood that after the compensated CAD model has been generated, the component has been manufactured according to the compensated CAD model, and the component has been post-processed, the manufactured and post-processed component meets the original engineering requirements regarding dimensions and surface finish of the features thereof.

In the embodiment shown, the step of predicting compensations for each one of the features of the component 130 comprises the substep 131 of analyzing the original CAD model and identifying features of the component defining the geometry of the component defined by the original design parameters and the further substep 132 of calculating (or estimating) the deviation to be caused by the post-processing procedures for each one of the identified features and including compensation for each one of the identified features in the generated compensation data.

In an embodiment, the step 132 of calculating (or estimating) the deviation to be caused by the post-processing procedures for each one of the identified features includes providing a training dataset 132a and predicting the deviation to be caused by the post-processing procedures for each feature of the component using a machine learning algorithm trained using the training dataset 132b and generating a machine learning model.

In an embodiment, the step 132 of calculating the deviation to be caused by the post-processing procedures for each one of the identified features can further include generating deviation data using theoretical modeling of the deviations for each one of the features from at least one theoretical model. As mentioned above, in an embodiment, the theoretical modeling can be performed using numerical analysis for the impact of the abrasive media used for the post-processing procedures on the features defining the geometry of the component. For example and without being limitative, in an embodiment, a computational fluid dynamics (CFD) analysis relative to the features defining the geometry of the component, the material of the component, the abrasive media used as fluid for the post-processing procedures, and the specific parameters of the post-processing procedure (time, required finish, etc.) can be performed to model the removal of material which will occur during the post-processing procedure

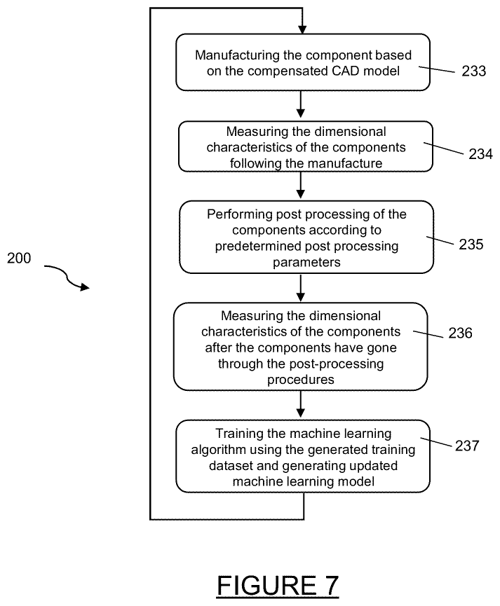

Now referring to FIG. 7 a subprocess 200 for providing the training dataset and training the machine learning algorithm can be provided.

In an embodiment, the training dataset comprises measurement data relative to geometric deviations caused by different post-processing procedures and for different component features, component geometries and component materials. In an embodiment, the measurement data can be generated by experimentation using an array of post-processing procedures data, finishing material data, component materials data, and components features/geometries data, for a plurality of experimentation instances that are similar or different from the engineering parameters of the current component for which the dimension compensations are being generated. In the embodiment shown in FIG. 7, the measurement data can be generated by the step 233 of manufacturing components, for example from the compensated CAD model, the step 234 of measuring the dimensional characteristics of the components following the manufacture thereof, the step 235 of performing post processing of the components according to predetermined post processing parameters, and the step 236 of measuring the dimensional characteristics of the components after the components have gone through the post-processing procedures. The measurement differences between the measurements from each instance of manufactured component and the corresponding post-processed component can then be used to generate the training dataset in combination with the corresponding post-processing procedures data, finishing materials data, component materials data, and components features/geometries data for each instance. The subprocess 200 can further include the step 237 of training the machine learning algorithm using the generated training dataset.

As can be seen, the subprocess 200 is iterative and the steps 233, 234, 235 and 236 can be repeated for numerous components in order to repeatedly update the training dataset, and the step 237 of training the machine learning algorithm using the generated training dataset can also be performed repeatedly to train the machine learning algorithm using the latest updated training dataset and generate an updated machine learning model.

It should be appreciated by those skilled in the art that any block diagrams herein represent conceptual views of illustrative circuitry embodying the principles disclosed herein. Similarly, it will be appreciated that any flow charts and transmission diagrams, and the like, represent various processes which may be substantially represented in computer-readable medium and so executed by a computer or processor, whether or not such computer or processor is explicitly shown.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention could be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

1. A system for assisting the design of manufactured components requiring post-processing, through prediction of geometrical deviations created by at least one post-processing procedure to be performed on a component following a manufacture thereof, the system comprising:
an input module receiving original design data relative to a component to be manufactured and requiring post processing, the original design data defining engineering requirements of the component including a material of the component, a geometry of the component defining features and dimensional accuracy thereof and a surface finish, the input module further receiving manufacturing and post-processing data including the at least one post-processing procedure to be performed on the manufactured component and specific parameters of the at least one post-processing procedure;
a compensation determination module receiving the original design data and the manufacturing and post-processing data from the input module and being configured to predict the geometrical deviations created by the at least one post-processing procedure and generate dimension compensation data defining compensations for each one of the features of the component, the dimension compensation data being generated using at least one machine learning model generated by at least one machine learning algorithm trained using a training dataset; and
a compensated model generation module configured to receive the compensation data from the compensation determination module and to generate a compensated Computer Assisted Design (CAD) model including the compensations for each one of the features of the component, to counterbalance the deviation to be caused by the at least one post-processing procedure.

2. The system of claim 1, wherein the original design data comprises an original CAD model of the component responding to the engineering requirements.

3. The system of claim 1, wherein the manufacturing and post-processing data comprises data relative to the identification of the manufacturing process, the identification of the specific apparatus used for the manufacturing process and the material used in the manufacturing process.

4. The system of claim 1, wherein the compensation determination module is configured to generate the dimension compensation data defining different compensations for each one of the features of the component, the compensation corresponding to each one of the features of the component being adapted to the positioning and configuration of the corresponding feature.

5. The system of claim 1, wherein the compensation determination module is further configured to generate the compensation data using calculated deviations from theoretical modeling of the deviations for each one of the features in combination with the at least one machine learning model.

6. The system of claim 5, wherein the theoretical modeling includes a computational fluid dynamics (CFD) analysis relative to the features defining the geometry of the component, the material of the component, an abrasive media used as fluid for the at least one post processing procedures and the specific parameters of the post-processing procedure.

7. The system of claim 1, further comprising a manufacturing and post-processing unit comprising a manufacturing apparatus configured to receive the compensated CAD model and to manufacture the component according to parameters of the compensated CAD model and a post-processing apparatus configured to perform the at least one post-processing procedure on the component manufactured according to the compensated CAD model.

8. The system of claim 7, wherein the manufacturing apparatus is a 3D printer manufacturing the component using additive manufacturing.

9. The system of claim 1, further comprising a machine learning module including an artificial intelligence unit implementing the machine learning algorithm trained using the training dataset, a manufactured component measurement module configured to acquire dimensional data relative to the features of a manufactured component after the component has been manufactured and a post-processed component measurement module configured to acquire dimensional data relative to the features of the component after the component has gone through the at least one post-processing procedure, the data acquired by the manufactured component measurement module and the post-processed component measurement module being correlated with the engineering requirements of the component and information from the manufacturing and post-processing data to populate the training dataset.

10. A system for assisting the design of manufactured components requiring post-processing, the system comprising:
an input module receiving original design data relative to a component to be manufactured and requiring post processing, the original design data including an original CAD model of the component respecting engineering requirements including a material of the component, a geometry of the component defining features and dimensional accuracy thereof and a surface finish, the input module further receiving manufacturing and post-processing data including the at least one post-processing procedure to be performed on the manufactured component and specific parameters of the at least one post-processing procedure;
a compensation determination module receiving the original design data and the manufacturing and post-processing data from the input module and being configured to predict the geometrical deviations created by the at least one post-processing procedure and generate dimension compensation data defining compensations to be applied on the original CAD model for each one of the features of the component, the dimension compensation data being generated using a combination of empirical analysis performed by a machine learning model generated by at least one machine learning algorithm trained using a training dataset and theoretical modeling of the deviations for each one of the features using at least one theoretical model;
a compensated model generation module configured to receive the compensation data from the compensation determination module and to generate a compensated CAD model based on the original CAD model further including the compensations for each one of the features of the component defined therein, to counterbalance the deviation to be caused by the at least one post-processing procedure.

11. The system of claim 10, wherein the manufacturing and post-processing data comprises data relative to the identification of the manufacturing process, the identification of the specific apparatus used for the manufacturing process and the material used in the manufacturing process.

12. The system of claim 10, wherein the compensation determination module is configured to generate dimension compensation data defining different compensations for each one of the features of the component of the original CAD model, the compensation corresponding to each one of the features of the component being adapted to the positioning and configuration of the corresponding feature.

13. The system of claim 10, wherein the theoretical modeling includes a computational fluid dynamics (CFD) analysis relative to the features defining the geometry of the component, the material of the component, an abrasive media used as fluid for the at least one post processing procedures and the specific parameters of the post-processing procedure.

14. The system of claim 10, further comprising a manufacturing and post-processing unit comprising a manufacturing apparatus configured to receive the compensated CAD model and to manufacture the component according to parameters of the compensated CAD model and a post-processing apparatus configured to perform the at least one post-processing procedure on the component manufactured according to the compensated CAD model.

15. The system of 14, wherein the manufacturing apparatus is a 3D printer manufacturing the component using additive manufacturing.

16. The system of claim 10, further comprising a machine learning module including an artificial intelligence unit implementing the machine learning algorithm trained using the training dataset, a manufactured component measurement module configured to acquire dimensional data relative to the features of a manufactured component after the component has been manufactured and a post-processed component measurement module configured to acquire dimensional data relative to the features of the component after the component has gone through the at least one post-processing procedure, the data acquired by the manufactured component measurement module and the post-processed component measurement module being correlated with the engineering requirements of the component and information from the manufacturing and post-processing data to populate the training dataset.

17. A computer implemented method for assisting the design of manufactured components requiring post-processing, through prediction of geometrical deviations created by at least one post-processing procedure to be performed on a component following a manufacture thereof, the method comprising the steps of:
acquiring original design parameters relative to the component to be manufactured according to engineering requirements, the engineering requirements including the material of the component, the geometry of the component defining features and dimensional accuracy thereof and the surface finish;
acquiring manufacturing and post-processing input parameters regarding the component including the at least one post-processing procedure to be performed on the manufactured component and specific parameters of the at least one post-processing procedure to generate a finished component;
providing a training dataset, wherein the training dataset comprises measurement data relative to geometric deviations caused by different post-processing procedures and for different component features, component geometries and component materials, which are similar or different from the engineering requirements of the component;
predicting compensations for each one of the features of the component corresponding to deviations to occur subsequently during the at least one post-processing procedure such that the finished component respects the engineering requirements regarding the dimensional accuracy and the surface finish and generating dimension compensation data for the features of the component, wherein the prediction of the compensations are determined using a machine learning model generated by a machine learning algorithm trained using the training dataset; and
generating a compensated CAD model including compensations for the predicted deviations to occur to the corresponding features of the component during the at least one post-processing procedure based on the dimension compensation data, the compensated CAD model including specific compensations for each one of the features of the component.

18. The method of claim 17, further comprising the step of manufacturing the component according to the compensated CAD model.

19. The method of claim 18, further comprising the step of performing the at least one post-processing procedure on the manufactured component, to generate the finished component.

20. The method of claim 19, further comprising the steps of:
measuring the component after the component has been manufactured in accordance with the compensated CAD model;
measuring the component after the at least one post processing procedure has been performed on the manufactured component; and
updating the training dataset using the data relative to measurement differences between the measurements after the component has been manufactured and after the at least one post processing procedure has been performed on the manufactured component correlated with the engineering requirements of the component and the manufacturing and post-processing input parameters relative thereto.

21. The method claim 17, wherein the step of predicting compensations for each one of the features of the component comprises the substeps of analyzing an original CAD model and identifying features of the component defining the geometry of the component and calculating the deviation to be caused by the post-processing procedures for each one of the identified features and including compensation for each one of the identified features in the generated compensation data.

22. The method of claim 21, wherein the of calculating the deviation to be caused by the post-processing procedures for each one of the identified features can further include generating deviation data using theoretical modeling of the deviations for each one of the features from at least one theoretical model.
